(19) United States
(12) Patent Application Publication
(10) Pub. No.: US 2003/0168790 A1
(43) Pub. Date: Sep. 11, 2003

(54) Multiple layered highly damped vibration and shock damper with low outgassing properties

(76) Inventor: Erik S. Larson, Norwood, MA (US)

Correspondence Address: Thomas E. Hagar, 129 Boston Post Road, Wayland, MA, 01778, US

(21) Appl. No.: 10/090,953

(22) Filed: Mar. 5, 2002

(51) Int. Cl. F16M 13/00

(52) U.S. Cl. 267/141; 248/562

(57) ABSTRACT

The present invention relates to vibration dampening devices that require the benefits of both a highly damped material and a low outgassing material. Such damper needs are required in dampers operating in a vacuum environment. The present invention joins a highly damped material with a low outgassing resilient material resulting in a vibration and shock damper that is highly damped and achieves low outgassing performance. The invention therefore reduces the outgassing of low molecular weight volatiles while at the same time achieving a highly damped vibration and shock damper. Consequently, the dampening qualities of the damper are maintained while the environment in which the damper is operating does not become contaminated.

### BACKGROUND

a) Field of the Invention

This invention relates to the industry of vibration dampers where outgassing of low molecular weight volatiles is critical, such as in vacuum environments. Vibration damping devices are used in vacuum environments in such applications as industrial, aerospace and power generation.

Typically the elastomeric portion of a damper is made from a low sheer modulus, highly damped material. Although these materials have highly damped properties, they have poor outgassing performance. On the other hand, materials made from a resilient low tensile strength elastomer have very good outgassing performance but poor damping properties. The present invention combines the benefits of the two materials to achieve a damper that has both the desired damping properties while maintaining a very low outgassing of volatiles.

b) Description of the Related Art

Vibration and/or shock emanate from many sources and resonate frequencies in structures. Vibration dampening devices are employed to reduce the effect of the transmitted vibration and shock to the structure.

Vibration and shock control is vital to several industries that produce products such as automobiles, guidance systems, computers and other electronics devices. In some of these applications a vibration damper operates in a vacuum environment. Dampers operating in a vacuum environment can have a negative side effect of outgassing low molecular weight volatiles resulting in a reduction of vacuum, a reduction in the performance of the damper, contamination of the vacuum environment and the vacuum components.

The present invention is specifically designed to operate in a vacuum environment while significantly reducing the negative side effects of outgassing volatiles. The existing prior art does not perform the functions of the present invention. Furthermore, the prior art does not individually or collectively disclose the essential novel elements of the present invention; namely, a multiple layered damper consisting of dampening layers providing the predominate share of dampening and other dampening layers designed towards reducing the problematic outgassing. If needed, an exterior layer or coating may be added to the exterior of the damper to increase structural integrity while further reducing the outgassing.

The main dampening portion of the invention is made from a low shear modulus, highly damped elastomeric material. While the outgassing reduction portion of the invention is made from a resilient low tensile strength elastomer with low outgassing properties and sufficient structural integrity to enhance the structural quality of the entire damper. Some of the prior art lack the outgassing reduction portion of the damper thereby making the designs not a viable option for a damper operating in a vacuum environment. Some of the prior art possess an exterior coating, but are not designed to be used in the harsh vacuum environment or are not made from the same material as the present invention. For example, 3M's Vibration and Shock Attenuating Article (U.S. Pat. No. 6,251,493) is specifically designed for use at ambient atmospheric pressure in computer hardware or other electronics. The 3M product does not anticipate and is not intended for use in a vacuum environment. Furthermore, it does not incorporate the ingenious design of using two differ types of dampening materials in union to manufacture a product that has both excellent dampening qualities and the benefit of low outgassing. Lastly, it does not significantly reduce the outgassing of volatiles into the vacuum environment, as does the present invention.

A damper without a low outgassing exterior layer, such as a low outgassing dampening material or an exterior film, is directly exposed to its environment. Therefore, the damper could potentially become contaminated by its environment thereby reducing its dampening properties. In addition, a damper without a low outgassing exterior layer could react with the environment and potentially create secondary chemical components that in turn could exacerbate the outgassing problem or contaminate the damper. An uncovered damper could also potentially outgas vital volatiles that are critical to its dampening properties. Lastly and most critically, outgasses that emanate from an uncovered damper will reduce a vacuum and cause potential damage and reduced efficiency to the mechanisms which maintain the vacuum.

A properly designed low outgassing exterior layer on a damper used in a vacuum environment can provide many advantages over an exposed damper. First, an exterior layer can significantly reduce outgassing thereby reducing vacuum and contamination problems. Second, an exterior layer can protect the damper from contamination from the environment it is operating in. Third, the exterior layer can enhance the structural qualities of the damper thereby increasing its performance life. And lastly, the need to pre-outgas a damper will not be required when an exterior layer is used. Dampers which do not have a low outgassing exterior layer need to be pre-outgassed by heating the dampers to an elevated temperature in a vacuum over for a given period of time. Unfortunately, this increases the cost and complexity of the damper's manufacturing process and can potentially be a source for contaminating the damper. Consequently, the invention overcomes the shortcomings of the prior art to produce a damper that can be used in a vacuum environment while experiencing a significant reducing in outgassing.

### SUMMARY OF THE INVENTION

The present invention is directed to dampers that operate in a vacuum environment where the reduction of outgassing is critical. The novel design incorporates the combination of multiple layers of highly damped and low outgassing materials. Typically, dampening materials that possess a high dampening quality possess poor outgassing performance. While on the other hand, dampening materials that possess excellent outgassing performance typically have poor dampening qualities. The present invention solves this problem by joining different types of dampers in just the right ratio for a given environment to produce a damper that provides high dampening with low outgassing. The highly damped materials are completely disposed within the low outgassing materials thereby producing a product that has the desired dampening qualities while at the same time significantly reducing the negative side effects of outgassing volatiles. The highly damped layers are made from a highly damped material with the preferred embodiment being a low modulus high damped elastomeric polymer. The exterior layers are made from a low outgassing dampening material with sufficient structural integrity to stiffen the damper. The preferred embodiment of the exterior layer would be a low tensile strength elastomer material such as a fluorinated polymer.

If the application requires, an exterior film may be added to aid in reducing the outgassing. The exterior film is made from a non-ferrous metal with the preferred embodiment being aluminum or nickel.

By placing the low outgassing layer on the exterior, the manufacturing step of pre-outgassing the damper is eliminated thereby simplifying the process while reducing manufacturing costs. Further, the exterior layer protects the damper from contamination from its environment and provides additional structure integrity to the damper thereby increasing its life.

Accordingly, one object of this invention is to provide a damper that can significantly reduce outgassing of volatiles in a vacuum environment.

Another object of this invention is to streamline the manufacturing process of said damper by eliminating the need to pre-outgas the damper prior to use.

A third object of this invention is to prevent the contamination of the damper by its environment thereby extending the life of the damper by maintaining its damping performance and preventing any additional outgassing caused by a contaminated damper.

A fourth object of this invention is a damper with enhanced structural integrity thereby extending the performance and life of the damper.

Other objects and advantages of this invention will become apparent from the following detailed description taken in conjunction with the accompanying drawings.

### BRIEF DESCRIPTION OF THE DRAWINGS

These and other features, aspects and advantages of the present invention will become better understood with reference to the following description, appended claims, and accompanying drawings where,

FIG. 1.0 is an external prospective view of the invention in one of its various shape (cubical),

FIG. 2.0 is a cross-sectional view of the preferred embodiment of the invention showing a variant of the invention consisting of one layer each of the highly damped material, the low outgassing material and the external film,

FIG. 3.0 is a cross-sectional view of the preferred embodiment of the invention showing a variant of invention consisting of two layers of the highly damped material and three layers of the low outgassing material,

FIGS. 4.0-7.0 are cross-sectional prospective views of the preferred embodiment of the invention in a variety of shapes: FIG. 4.0—square, FIG. 5.0—rectangle, FIG. 6.0—triangle, FIG. 7.0—star,

FIG. 8.0 is a plan view of the preferred embodiment of the invention as an O-ring in a shaft mount device,

FIG. 9.0 is a cross-sectional view of the preferred embodiment of the invention as an O-ring in a shaft mount device.

### DETAILED DESCRIPTION OF THE PREFERRED EMBODIMENT

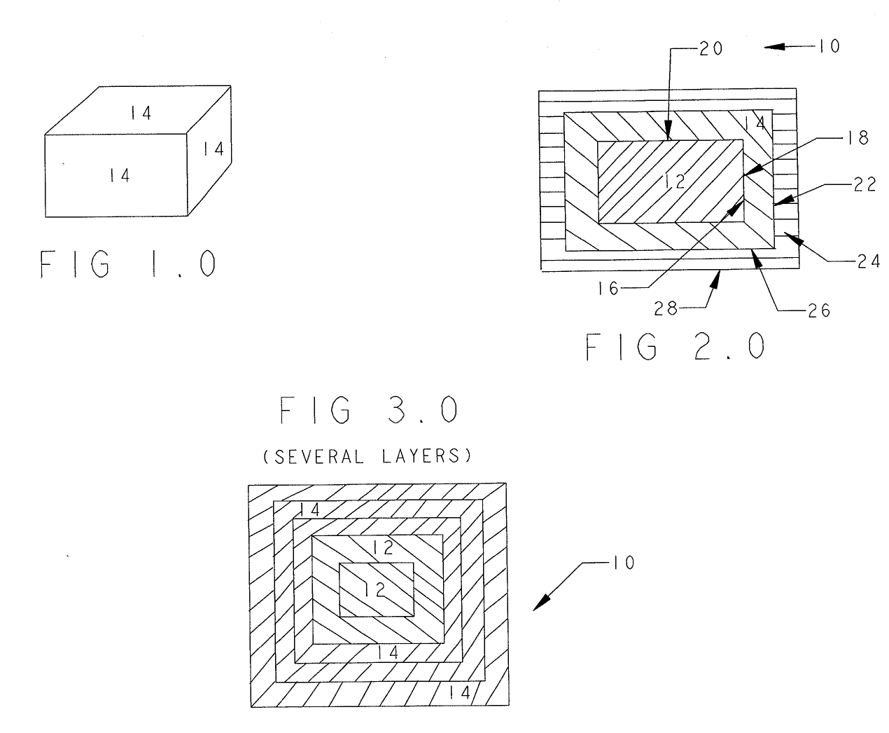

Referring to the Figures and more specifically FIG. 1 and FIG. 2, the invention consists of multiple layers of damping materials. The highly damped layer 12 is disposed completely inside the low outgassing layer 14. The highly damped layer 12 has an exterior surface 16. The low outgassing layer 14 has an interior surface 18 and an exterior surface 22. The exterior surface 16 of the highly damped layer 12 and the interior surface 18 of the low outgassing layer 14 are connected at 20. Two layers will be vulcanized together at the point 20. The exterior surface 22 of the low outgassing layer 14 is the outside portion of the invention 10 and therefore the portion of the damper that is exposed to its environment.

The highly damped layer 12 is completely disposed within the low outgassing layer 14 so that it is protected from its environment. The low outgassing layer 14 acts as an outgassing reduction barrier thereby preventing the volatiles outgassing from the highly damped layer 12 to the operating environment. Consequently, the highly damped layer 12 retains it dampening ability and the environment the damper is working within does not become contaminated.

The highly damped layer 12 is made of any highly damped material with the preferred embodiment being a low modulus high damped elastomeric polymer. The low outgassing layer 14 is made from a dampening material that possesses low outgassing properties with the preferred embodiment being a fluorinated polymer.

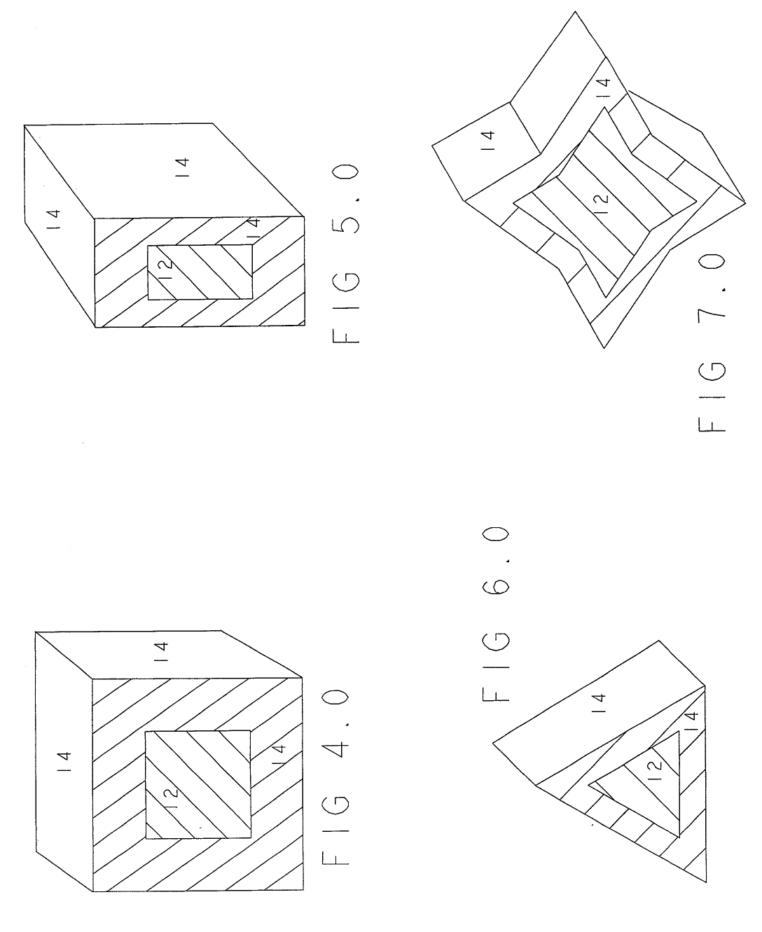

If an additional exterior layer is desired, an exterior coating 24 may be added to the outermost low outgassing layer 14 (see FIG. 2). The additional exterior layer 24 has an interior surface 26 and an exterior surface 28. The interior surface 26 of the exterior coating 24 is adhered to the exterior surface 22 of the low outgassing layer 14. In the case of multiple low outgassing layers 14 the external coating is adhered to the outermost low outgassing layer 14 (see FIG. 3). The exterior coating 24 is made from a non-ferrous metal with the preferred embodiment being aluminum or nickel. The metal may be added to the damper using a vacuum metalizing method. The exterior layer 24 may be added to a desired thickness with the preferred embodiment being 50 angstroms.

The invention 10 could be manufactured in several different shapes depending on the application requirements. For example, a cubical (FIG. 4), rectangular (FIG. 5), triangular (FIG. 6), star (FIG. 7), etc. However, regardless of the particular shape, the highly damped layer 12 is always completely disposed within the low outgassing layer 14 in order to achieve the desired results.

If necessary, the invention 10 may utilize several layers of the highly damped layer 12 and/or the low outgassing layer 14. FIG. 3 shows a design with two layers of the highly damped layer 12 and three layers of the low outgassing layer 14. This may be necessary if the application requires a combination of different highly damped materials and different low outgassing materials.

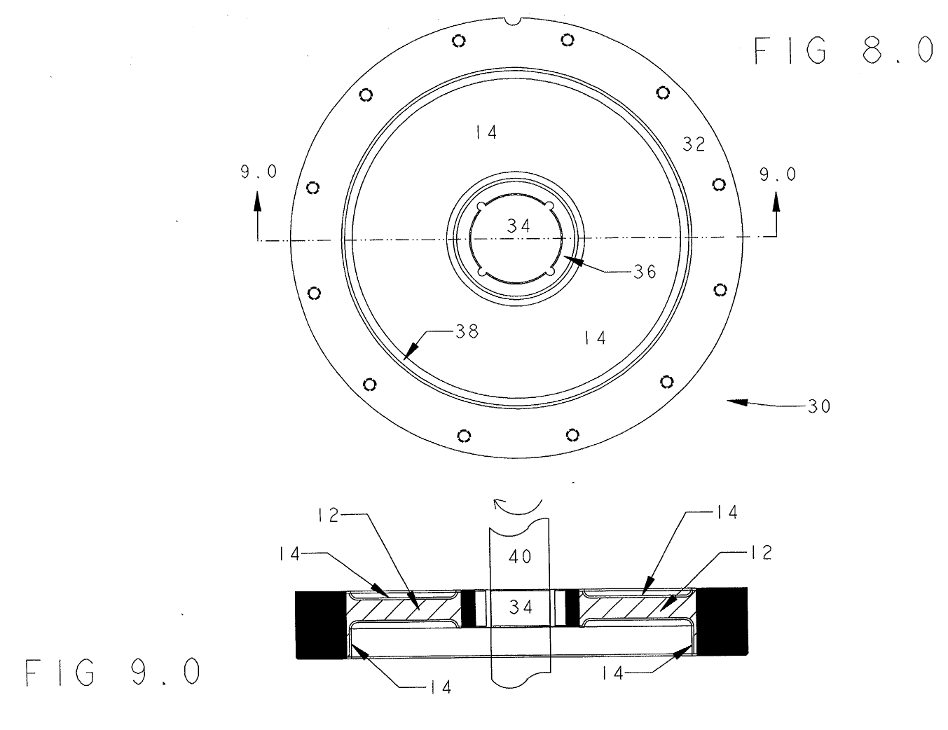

FIG. 8 and FIG. 9 are an illustration of the invention being used as a damper in a shaft mount device 30. The invention takes the shape similar to an O-ring and is disposed between an inner race 36 and an outer race 38 of a shaft mount device 30. The shaft mount 30 is attached to a frame using a flange 32. A shaft 40 runs through the shaft mount device 30 via an open space 34 in the inner race 36. The change in the rotational speed of the shaft 40 creates vibration and shock that will cause the shaft 40 to become unbalanced from its center axis. The invention absorbs a significant amount of this vibration and shock energy thereby significantly reducing the transmitted unbalanced energy of the rotating shaft 40. As one can see from this application the highly damper layer 12 is completely disposed within the low outgassing layer 14 and also comprises a significant portion of the overall damper.

What is claimed is:

1) A Multiple Layered Highly Damped Vibration and Shock Damper with Low Outgassing Properties comprising:
1) A multiple of highly damped layers and low outgassing layers;
where said highly damped layers are completely disposed within said low outgassing layers;
where each of said highly damped layers and said low outgassing layers have an interior and exterior surface with the exception of the innermost highly damped layer which only has an external surface;
where the said layers are oriented in such a matter that the exterior surface of a given layer is connected to the interior surface of an adjoining layer.

2) A Multiple Layered Highly Damped Vibration and Shock Damper with Low Outgassing Properties as is claim 1 wherein the highly damped layer is made of a low modulus elastomeric polymer.

3) A Multiple Layered Highly Damped Vibration and Shock Damper with Low Outgassing Properties as is claim 1 wherein the low outgassing layer is made of a fluorinated polymer.

4) A Multiple Layered Highly Damped Vibration and Shock Damper with Low Outgassing Properties as is claim 1 where an exterior coating is applied to the exterior surface of the outermost low outgassing layer.

5) A Multiple Layered Highly Damped Vibration and Shock Damper with Low Outgassing Properties as is claim 4 where an exterior coating is made out of a nonferrous metal such as aluminum or nickel.
